(19) United States
(12) Patent Application Publication
(10) Pub. No.: US 2016/0173668 A1
(43) Pub. Date: Jun. 16, 2016

(54) METHOD AND DEVICE FOR ACTIVATING AN OPERATING STATE OF A MOBILE TERMINAL

(71) Applicant: Xiaomi Inc., Beijing (CN)

(72) Inventors: Kun YANG, Beijing (CN); Jun TAO, Beijing (CN); Zhongsheng JIANG, Beijing (CN)

(73) Assignee: Xiaomi Inc.

(21) Appl. No.: 14/810,548

(22) Filed: Jul. 28, 2015

Related U.S. Application Data
(63) Continuation of application No. PCT/CN2015/077827, filed on Apr. 29, 2015.

(30) Foreign Application Priority Data
Dec. 16, 2014 (CN) 201410784576.1

(51) Int. Cl. H04M 1/02; G06F 3/041

(52) U.S. Cl. CPC H04M 1/0281; G06F 3/041

(57) ABSTRACT

A method for activating an operating state of a mobile terminal, includes: measuring a first duration during which a palm contact event lasts on a screen of the mobile terminal; measuring a second duration during which a finger touches the screen; and determining to activate an operating state on the mobile terminal based on the first duration and the second duration.

### CROSS-REFERENCE TO RELATED APPLICATIONS

The present application is a continuation of International Application No. PCT/CN2015/077827, filed Apr. 29, 2015, which is based upon and claims priority to Chinese Patent Application No. 201410784576.1, filed Dec. 16, 2014, the entire contents of all of which are incorporated herein by reference.

### TECHNICAL FIELD

The present disclosure generally relates to the field of electronic technologies and, more particularly, to a method and a device for activating an operating state of a mobile terminal.

### BACKGROUND

A user may hold an electronic apparatus with one hand, especially one with a relatively large screen. After entering a single-hand mode, the related art ignores a region of the screen that contacts any part of a user's palm and merely recognizes touch operations at other touch regions.

### SUMMARY

According to a first aspect of the present disclosure, there is provided a method for activating an operating state of a mobile terminal, comprising: measuring a first duration during which a palm contact event lasts on a screen of the mobile terminal; measuring a second duration during which a finger touches the screen; and determining to activate an operating state on the mobile terminal based on the first duration and the second duration.

According to a second aspect of the present disclosure, there is provided a mobile terminal comprising: a processor; and a memory for storing instructions executable by the processor; wherein the processor is configured to: measure a first duration during which a palm contact event lasts on a screen of the mobile terminal; measure a second duration during which a finger touches the screen; and determine to activate an operating state on the mobile terminal based on the first duration and the second duration.

According to a third aspect of the present disclosure, there is provided a non-transitory computer-readable storage medium having stored therein instructions that, when executed by one or more processors of a mobile terminal, cause the mobile terminal to: measure a first duration during which a palm contact event lasts on a screen of the mobile terminal; measure a second duration during which a finger touches the screen; and determine to activate an operating state on the mobile terminal based on the first duration and the second duration.

It shall be understood that both the foregoing general description and the following details are exemplary and explanatory only and do not limit the present disclosure.

### BRIEF DESCRIPTION OF THE DRAWINGS

The accompanying drawings, which are hereby incorporated in and constitute a part of this specification, illustrate embodiments consistent with the invention and, together with the description, serve to explain the principles of the invention.

FIG. 1A is a flow chart showing a method for activating an operating state of a mobile terminal, according to an exemplary embodiment.

FIG. 1B is a diagram illustrating a palm contact location and a finger contact location, according to an exemplary embodiment.

FIG. 2 is a flow chart showing a method for activating an operating state of a mobile terminal, according to an exemplary embodiment.

FIG. 3A is a flow chart showing a method for activating an operating state of a mobile terminal, according to an exemplary embodiment.

FIG. 3B is a diagram illustrating a single-hand operating interface, according to an exemplary embodiment.

FIG. 3C is a diagram illustrating a navigation interface, according to an exemplary embodiment.

FIG. 4 is a block diagram illustrating a device for activating an operating state of a mobile terminal, according to an exemplary embodiment.

FIG. 5 is a block diagram illustrating a device for activating an operating state of a mobile terminal, according to an exemplary embodiment.

FIG. 6 is a block diagram illustrating an activation sub-module, according to an exemplary embodiment.

FIG. 7 is a block diagram illustrating a device for activating an operating state, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with some aspects related to the invention as recited in the appended claims.

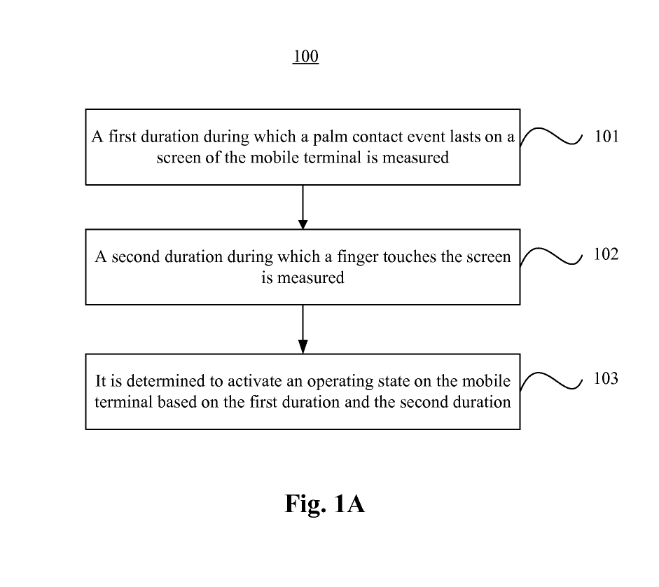

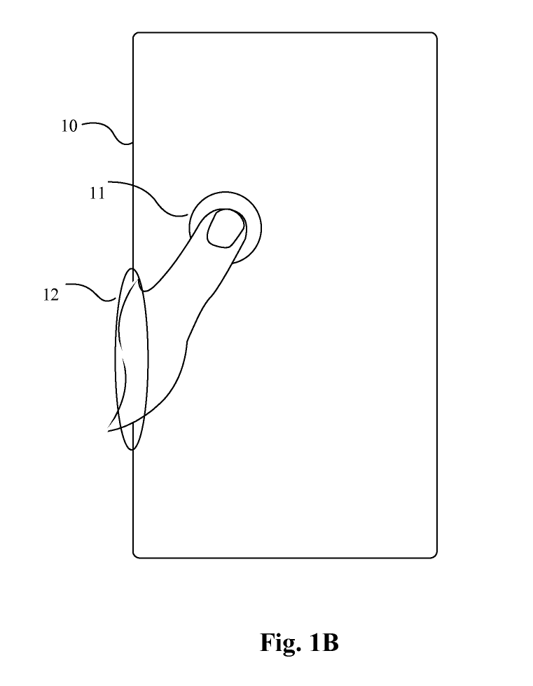

FIG. 1A is a flow chart showing a method 100 for activating an operating state of a mobile terminal, according to an exemplary embodiment. For example, the method 100 may be used on the mobile terminal such as a smartphone or a tablet computer. Referring to FIG. 1A, the method 100 includes the following steps.

In the step 101, a first duration during which a palm contact event lasts on a screen of the mobile terminal is measured.

For example, as shown in FIG. 1B, when a user holds a mobile terminal 10 in one hand, a touch control integrated circuit (IC) in the mobile terminal 10 recognizes a palm contact region 12 as a region in which any part of the user's palm contacts the mobile terminal 10, such as a part of the user's palm connected to the user's thumb. After recognizing the palm contact event, the touch control IC sends a corresponding message to a host in the mobile terminal 10. After the host receives the message, the host may start to measure a first duration during which the palm contact event lasts. FIG. 1B depicts an exemplary embodiment in which the user holds the mobile terminal 10 with his/her left hand. Those skilled in the art will understand that when the user holds the mobile terminal 10 with his/her right hand, a corresponding region exist on the right side of the mobile terminal 10 similar to the palm contact region 12.

In the step 102, a second duration during which a finger touches the screen is measured.

For example, as shown in FIG. 1B, when a finger of the user touches the screen of the mobile terminal 10, the touch control IC recognizes a finger contact region 11 as a touch location of the user's finger on the screen of the mobile terminal 10. After recognizing a finger touch event, the touch control IC sends a corresponding message to the host in the mobile terminal 10. After the host receives the message, the host may start to measure the second duration during which the finger touch event lasts. Furthermore, the embodiment of the present disclosure may measure the duration for one finger or multiple fingers. Accordingly, the finger touch event may be a touch event of one finger, or a touch event of multiple fingers. Accordingly, the second duration may be a time period for which one finger touches the screen, or may be a time period for which multiple fingers touch the screen. The embodiment of the present disclosure does not limit the number of the fingers. Furthermore, the embodiment of the present disclosure does not limit whether the finger is moving, as long as the finger continuously touches the screen of the mobile terminal while the second duration is measured.

In the step 103, it is determined to activate an operating state on the mobile terminal based on the first duration and the second duration.

Different operating states may be activated by setting a length of the first duration and a length of the second duration. For example, in a case where the first duration exceeds 2 seconds, and the second duration exceeds 1.5 seconds, a single-hand mode in which the user holds the mobile terminal in one hand is activated; when the first duration exceeds 2 seconds, and the second duration exceeds 2 seconds, an operating interface is activated. Also for example, when the second duration exceeds 2 seconds, a single-hand operating interface is activated; and when the second duration exceeds 3 seconds, a navigation interface is activated, and so on. Accordingly, the user may determine a corresponding time threshold according to the user's preferences. The operating state can be, for example, an operating mode (e.g., a single-hand operating mode), or an operating interface (e.g., a single-hand mode option interface, a navigation interface, a cancel interface or a return interface, a contact book interface, etc.). The operating interface may be preset based on user preferences. For example, the user sets the preset operating interface to the single-hand mode option interface, and subsequent operations are determined to be single-hand operations by the option interface, thereby facilitating the user's operation of the mobile terminal. In another example, the user sets the preset operating interface to the contact book interface, and the user may directly select a target contact person from the contact book interface, such that the user may communicate with the target contact person more quickly.

In the present embodiment, a first duration of a palm contact event and a second duration of a finger touch event are measured, and an operating state on a mobile terminal is determined to be activated based on the first duration and the second duration. Thereby a user may be allowed to enter the operating state with a single-hand operation. Thus, the procedure for operating the mobile terminal may be simplified such that the user may quickly enter the operating state, and the experience of operating the mobile terminal by the user may be improved.

In an exemplary embodiment, the method 100 may further include: (1) when it is monitored that the finger touches the screen, recording a start time at which the finger begins touching the screen; (2) monitoring whether a touch region of the finger on the screen exceeds a preset deviation range beginning at the starting time; and (3) while it is monitored that the touch region does not exceed the preset deviation range, performing the above-described step 102.

In an embodiment, if the operating state includes an operating mode and an operating interface, the step 103 may further include: (1) if it is determined that the first duration exceeds a first preset threshold, and the second duration exceeds a second preset threshold, activating the operating mode; and (2) if the first duration exceeds the first preset threshold, and the second duration exceeds a third preset threshold, activating the operating interface, wherein the third preset threshold is greater than the second preset threshold.

In an embodiment, the operating interface includes at least a single-hand operating interface and a navigation interface, and the step of activating the operating interface may include: (1) if the second duration exceeds the third preset threshold, activating the single-hand operating interface; and (2) if the second duration exceeds a fourth preset threshold, activating the navigation interface, wherein the fourth preset threshold is greater than the third preset threshold.

In an embodiment, the operating interface further includes a return interface or a cancel interface, and after the activating the single-hand operating interface or activating the navigation interface, the method 100 may include activating the return interface or the cancel interface.

In an embodiment, the method 100 may further include determining the operating state based on an option setting of the mobile terminal.

Details of how to activate the operating interface on the mobile terminal are described in the following embodiments.

In the above-described embodiments, the user may be allowed to enter an operating state with a single-hand operation, and the procedure for operating the mobile terminal may be simplified such that the user may quickly enter the operating state, thereby improving the user's experience of operating the mobile terminal.

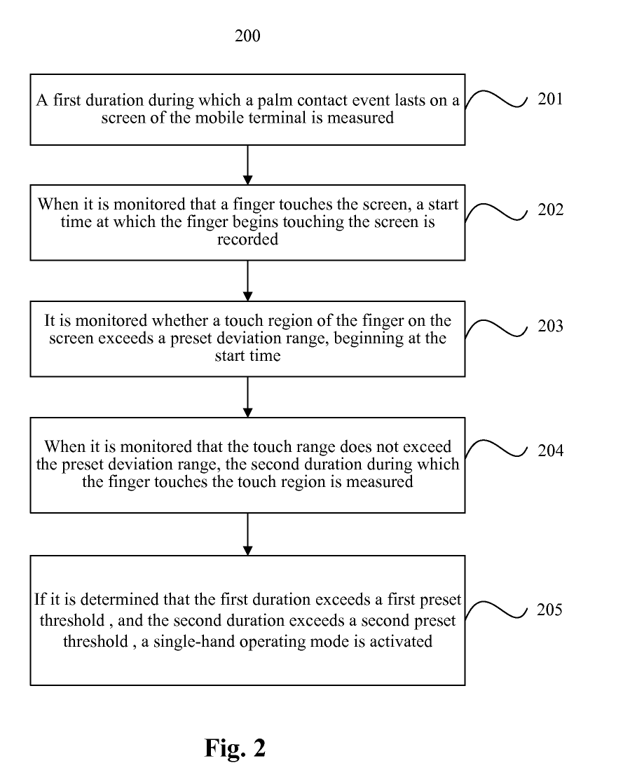

FIG. 2 is a flow chart showing a method 200 for activating an operating state of a mobile terminal, according to an exemplary embodiment. Referring to FIG. 2, the method 200 includes the following steps.

In step 201, a first duration during which a palm contact event lasts on a screen of the mobile terminal is measured, similar to step 101 (FIG. 1).

In step 202, when it is monitored that a finger touches the screen, a start time at which the finger begins touching the screen is recorded. For example, when it is monitored that a finger of a user touches the screen at 13 o'clock 15 minute 20 second on Dec. 4, 2014, this time point is recorded.

In step 203, it is monitored whether a touch region of the finger on the screen exceeds a preset deviation range, beginning at the start time.

In step 204, when it is monitored that the touch region does not exceed the preset deviation range, the second duration during which the finger touches the touch region is measured.

In the exemplary embodiment, the hand of the user may shake while operating the mobile terminal. Consequently, a location at which the user touches the screen with a finger might not always be fixed at a single point on the screen. In the embodiment of the present disclosure, it is monitored whether the touch region of the finger on the screen exceeds the preset deviation range to more precisely measure the second duration and activate the user interfaces more accurately.

In step 205, if it is determined that the first duration exceeds a first preset threshold, and the second duration exceeds a second preset threshold, a single-hand operating mode is activated.

In the present disclosure, an exemplary example is described in which a preset operating state is the single-hand operating mode, and by activating the single-hand operating mode, the user may directly enter the single-hand operating mode by operating the mobile terminal. Thus, the procedure for operating the mobile terminal may be simplified, such that the user may more conveniently and quickly operate the mobile terminal, thereby improving user's the experience of operating the mobile terminal.

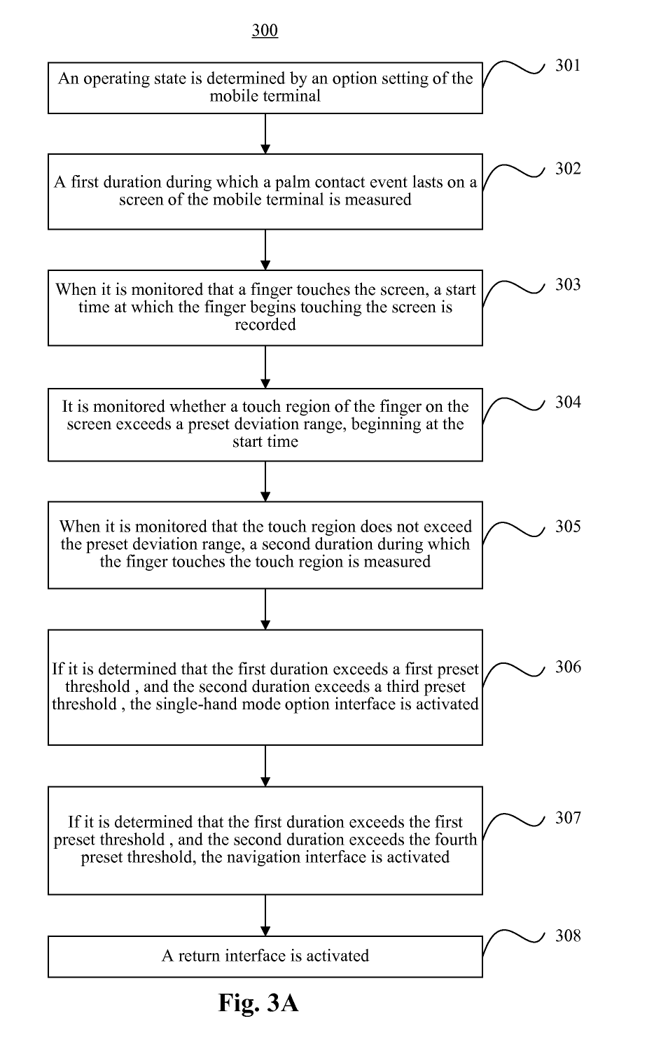

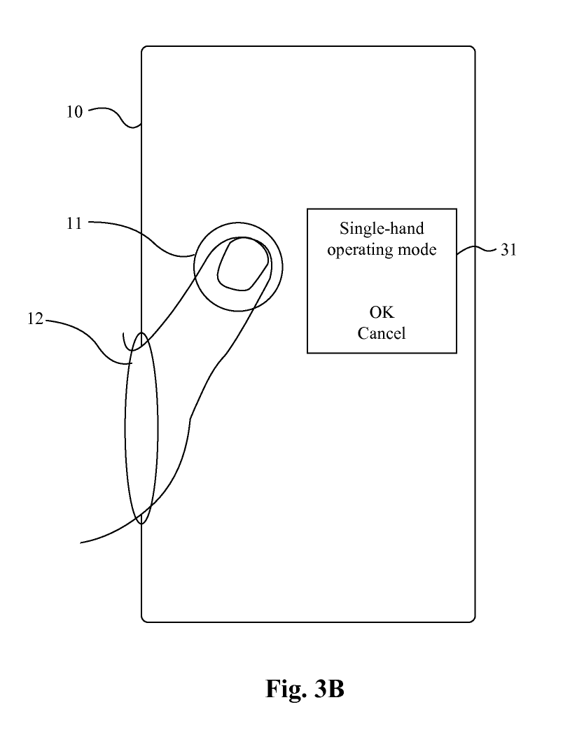

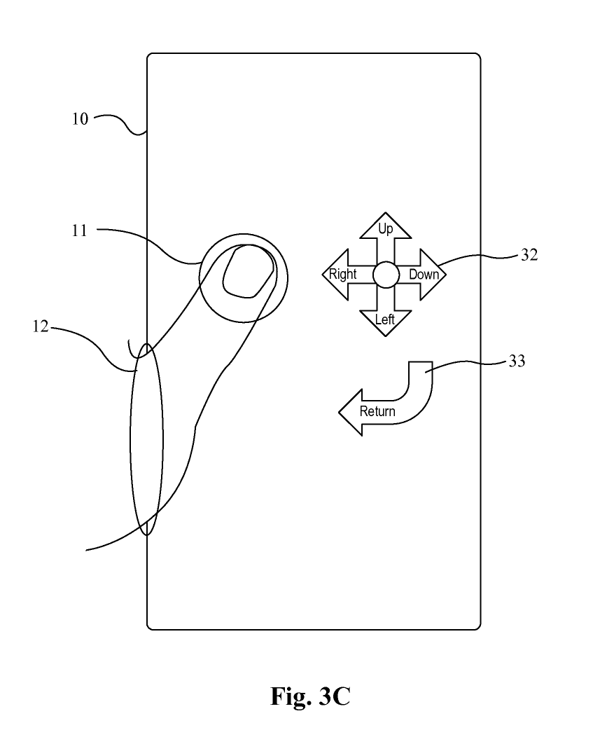

FIG. 3A is a flow chart showing a method 300 for activating an operating state of a mobile terminal, according to an exemplary embodiment. Referring to FIG. 3A, the method 300 includes the following steps.

In step 301, an operating state is determined by an option setting of the mobile terminal. In an embodiment, a user sets the operating state through an option setting, such that the activated user interface may more reflect the user's preferences, thereby improving the user's experience of operating the mobile terminal. For example, the user sets the operating state as the single-hand operating interface or the navigation interface through the option setting.

In step 302, a first duration during which a palm contact event lasts on a screen of the mobile terminal is measured, similar to step 201 (FIG. 2).

In step 303, when it is monitored that a finger touches the screen, a start time at which the finger begins touching the screen is recorded, similar to step 202 (FIG. 2).

In step 304, it is monitored whether a touch region of the finger on the screen exceeds a preset deviation range, beginning at the start time, similar to step 203 (FIG. 2).

In step 305, when it is monitored that the touch region does not exceed the preset deviation range, a second duration during which the finger touches the touch region is measured, similar to step 204 (FIG. 2).

In step 306, if it is determined that the first duration exceeds a first preset threshold and the second duration exceeds a third preset threshold, the single-hand mode option interface is activated.

For example, where the first preset threshold is 2 seconds and the second preset threshold is 1.5 seconds, by comparing the first duration with the first preset threshold and comparing the second duration with the second preset threshold, the activated operating state is determined. Furthermore, in order to activate more user interfaces, the embodiment of the present disclosure may also determine to activate a user interface on the mobile terminal based on a third preset threshold, a fourth preset threshold (e.g., a third preset threshold of 2.5 seconds, a fourth preset threshold of 3.5 seconds) or more preset thresholds. The preset thresholds in the embodiments of the present disclosure may be set based on user preferences and the embodiments of the present disclosure do not limit the time length of a specific threshold.

As shown in FIG. 3B, a single-hand mode option interface 31 on the mobile terminal may be initiated. In the single-hand mode option interface 31, options “OK” and “Cancel” are provided. By clicking the option “OK” in the single-hand mode option interface 31, the user may cause the mobile terminal 10 to enter a single-hand operating mode. Then, subsequent operations of the user may be based on the single-hand operating mode such that the user may more conveniently operate the mobile terminal.

In step 307, if it is determined that the first duration exceeds the first preset threshold, and the second duration exceeds the fourth preset threshold, the navigation interface is activated.

In an embodiment, the first duration is 2 seconds, the first preset threshold is 2 seconds, the second duration is 3 seconds, and the third preset threshold is 2.5 seconds. As shown in FIG. 3C, a virtual navigation interface 32 on the mobile terminal may be initiated. Its function setting may refer to an actual navigation button on the mobile terminal 10. In the navigation interface 32, options “up”, “down”, “left”, “right” and “OK” are provided and the functions of these five options are consistent with those of actual navigation buttons. By activating a navigation interface, the user may directly perform a corresponding operation of the mobile terminal 10, thereby more conveniently operating the mobile terminal.

In step 308, a return interface is activated.

As shown in FIG. 3C, when the operating interface is the navigation interface, a return interface 33 may be activated on the user interface of the mobile terminal, such that the user may return to a previous operating interface from the current operating interface, so as to ensure normal operation of the mobile terminal. Alternatively, the return interface may also be a cancel interface, as long as it may ensure that the user can return to a previous operating interface from a current operating interface.

In the present embodiment, an exemplary example is described where the operating interface is the single-hand mode option interface or the navigation interface. By activating the single-hand operating mode, which the user may choose to do by touching “OK” according to his/her own needs of operating the mobile terminal, subsequent operations of the user are in the single-hand operating mode. The user may thus more conveniently and quickly operate the mobile terminal, and the experience of operating the mobile terminal by the user may be improved. By activating a user interface in the form of a “virtual navigation interface”, the user may perform an actual navigation button function on the mobile terminal using the “virtual navigation interface.” The user may thus more conveniently and quickly operate the mobile terminal, and the experience of operating the mobile terminal by the user may be improved.

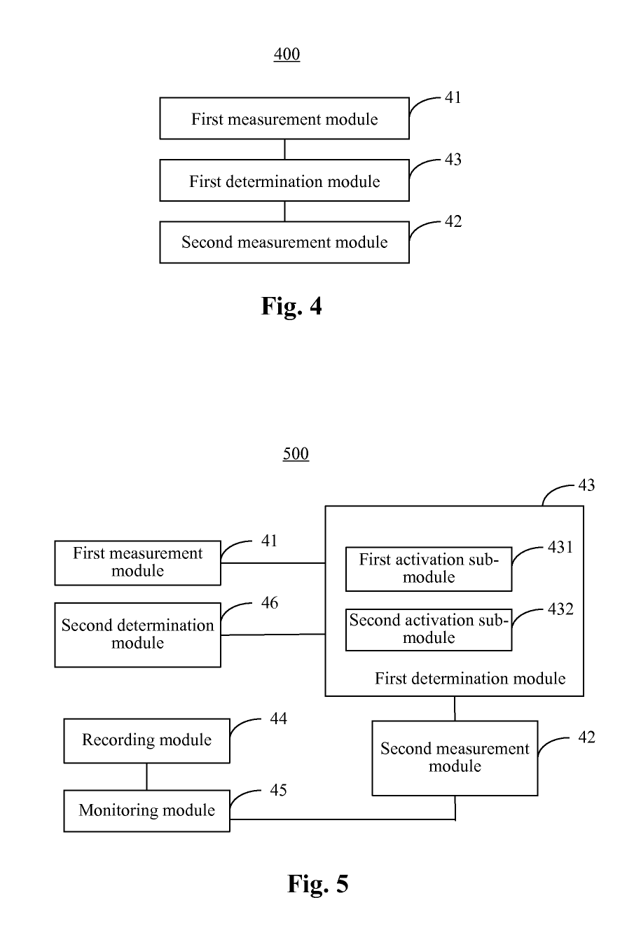

FIG. 4 is a block diagram illustrating a device 400 for activating an operating state of a mobile terminal, according to an exemplary embodiment. The device 400 may be a part of the mobile terminal or the whole mobile terminal. Referring to FIG. 4, the device 400 includes: a first measurement module 41 configured to measure a first duration during which a palm contact event lasts on a screen of the mobile terminal; a second measurement module 42 configured to measure a second duration during which a finger touches the screen; a first determination module 43 configured to determine to activate an operating state on the mobile terminal based on the first duration measured by the first measurement module 41 and the second duration measured by the second measurement module 42.

FIG. 5 is a block diagram illustrating a device 500 for activating an operating state of a mobile terminal, according to an exemplary embodiment. The device 500 may be a part of the mobile terminal or the whole mobile terminal. Referring to FIG. 5, the device 500 may further include: a recording module 44 configured to, when it is monitored that the finger touches the screen, record a start time at which the finger begins touching the screen, and a monitoring module 45 configured to monitor whether a touch region of the finger on the screen exceeds a preset deviation range, beginning at the start time recorded by the recording module 44. When the monitoring module 45 monitors that the touch region does not exceed the preset deviation range, the second measurement module 42 measures the second duration during which the finger touches the touch region.

In an embodiment, the operating state includes an operating mode and an operating interface, and the first determination module 43 may include: a first activation sub-module 431 configured to, if the first duration measured by the first measurement module 41 exceeds a first preset threshold and the second duration measured by the second measurement module 42 exceeds a second preset threshold, activate the operating mode; and a second activation sub-module 432 configured to, if the first duration measured by the first measurement module 41 exceeds the first preset threshold and the second duration measured by the second measurement module 42 exceeds a third preset threshold, activate the operating interface.

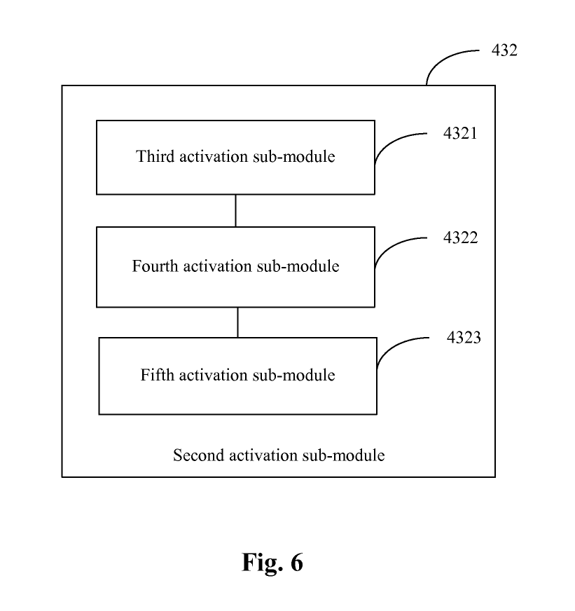

In an embodiment, the operating interface includes at least a single-hand operating interface and a navigation interface. As shown in FIG. 6, the second activation sub-module 432 may include: a third activation sub-module 4321 configured to, if the second duration measured by the second measurement module 42 exceeds the third preset threshold, activate the single-hand operating interface; and a fourth activation sub-module 4322 configured to, if the second duration measured by the second measurement module 42 exceeds a fourth preset threshold, activate the navigation interface, wherein the fourth preset threshold is greater than the third preset threshold.

In an embodiment, the operating interface may include a return interface or a cancel interface. As shown in FIG. 6, the second activation sub-module 432 may further include a fifth activation sub-module 4323 configured to activate the return interface or the cancel interface, after the third activation sub-module 4321 activates the single-hand operating interface or the fourth activation sub-module 4322 activates the navigation interface.

In an embodiment, the device 500 (FIG. 5) may further include a second determination module 46 configured to, based on an option setting of the mobile terminal, determine the operating state to be activated by the first determination module 43.

With respect to the devices in the above embodiments, the specific manner for performing operations for individual modules therein have been described in detail in the embodiments regarding the methods, and are not repeated here.

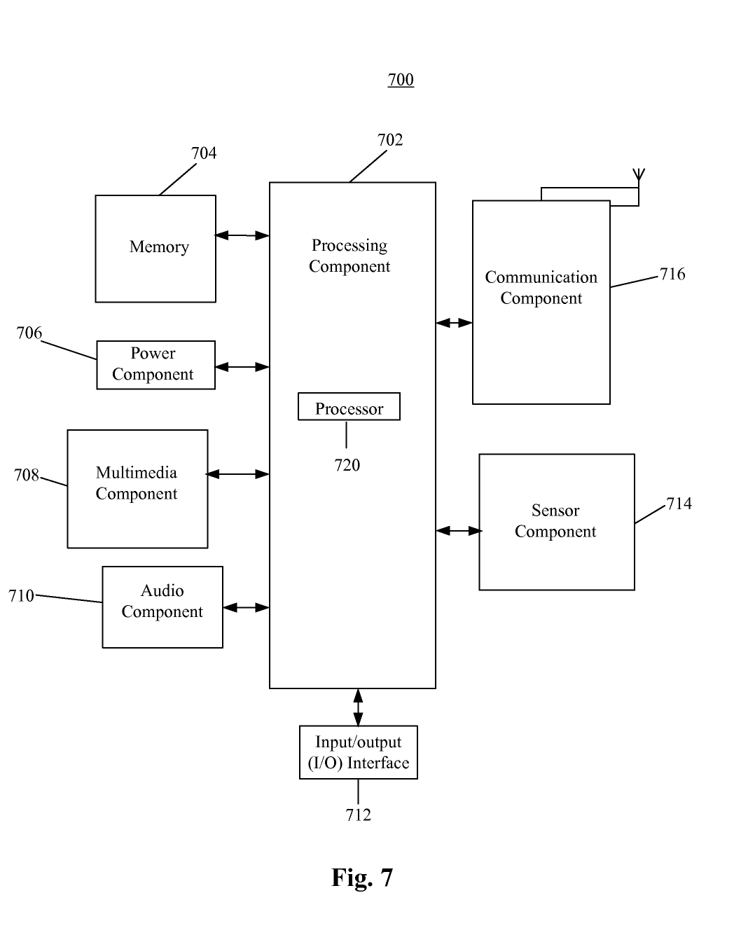

FIG. 7 is a block diagram illustrating a device 700 for activating an operating state, according to an exemplary embodiment. For example, the device 700 may be a mobile phone, a computer, a digital broadcast terminal, a messaging device, a gaming console, a tablet device, a medical device, exercise equipment, a personal digital assistant, or other similar device.

Referring to FIG. 7, the device 700 may include one or more of the following components: a processing component 702, a memory 704, a power component 706, a multimedia component 708, an audio component 710, an input/output (I/O) interface 712, a sensor component 714, and a communication component 716.

The processing component 702 usually controls the overall operations of the device 700, such as the operations associated with display operations, telephone calls, data communications, camera operations, and recording operations. The processing component 702 may include one or more processors 720 to execute instructions to perform all or a part of the steps in the above described methods. Moreover, the processing component 702 may include one or more modules which facilitate the interaction between the processing component 702 and other components. For instance, the processing component 702 may include a multimedia module to facilitate the interaction between the multimedia component 708 and the processing component 702.

The memory 704 is configured to store various types of data to support the operations of the device 700. Examples of such data include instructions for any application or method operated on the device 700, contact data, phonebook data, messages, pictures, videos, etc. The memory 704 may be implemented by using any type of volatile or non-volatile memory devices or combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power component 706 provides power to the respective components of the device 700. The power component 706 may include a power management system, one or more power sources, and other components associated with the generation, management, and distribution of power for the device 700.

The multimedia component 708 includes a screen providing an output interface between the device 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may sense not only a boundary of a touch or swipe action, but also a duration and a pressure associated with the touch or swipe action. In some embodiments, the multimedia component 708 includes a front camera and/or a rear camera. The front camera and/or the rear camera may receive external multimedia data while the device 700 is in an operating mode such as a photographing mode or a video mode. Each of the front camera and the rear camera may be a fixed optical lens system or have focus and optical zoom capability.

The audio component 710 is configured to output and/or input audio signals. For example, the audio component 710 includes a microphone configured to receive external audio signals when the device 700 is in an operating mode such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, such as a keyboard, a click wheel, a button, and the like. The button may include, but not limited to, a home page button, a volume button, a starting button, and a locking button.

The sensor component 714 includes one or more sensors to provide status assessments of various aspects of the device 700. For instance, the sensor component 714 may detect an open/closed status of the device 700, relative position of components (e.g., the relative positions of the display and the keyboard of the device 700), a change in position of the device 700 or a component of the device 700, a presence or absence of user contact with the device 700, an orientation of the device 700, an acceleration/deceleration of the device 700, and/or a change in temperature of the device 700. The sensor component 714 may include a proximity sensor configured to detect the presence of nearby objects without any physical contact. The sensor component 714 may further include a light sensor, such as a CMOS or CCD image sensor, for use in imaging applications. In some embodiments, the sensor component 714 may further include an accelerometer sensor, a gyroscope sensor, a magnetic sensor, a pressure sensor, and/or a temperature sensor.

The communication component 716 is configured to facilitate communication, in a wired or wireless manner, between the device 700 and other devices. The device 700 can access a wireless network based on a communication standard, such as WiFi, 2G or 3G, or a combination thereof. In one exemplary embodiment, the communication component 716 receives a broadcast signal or broadcast associated information from an external broadcast management system via a broadcast channel. In one exemplary embodiment, the communication component 716 further includes a near field communication (NFC) module to facilitate short-range communications. For example, the NFC module may be implemented based on a radio frequency identification (RFID) technology, an infrared data association (IrDA) technology, an ultra-wide band (UWB) technology, a Bluetooth (BT) technology, and/or other technologies.

In exemplary embodiments, the device 700 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors and/or other electronic components, for performing the above described methods.

In exemplary embodiments, there is provided a non-transitory computer-readable storage medium including instructions, such as those included in the memory 704, executable by the processor 720 in the device 700, for performing the above described methods. For example, the non-transitory computer-readable storage medium may be a ROM, a random access memory (RAM), a CD-ROM, a magnetic tape, a floppy disc, an optical data storage device, etc.

It should be understood by those skilled in the art that the above described modules can each be implemented through hardware, or software, or a combination of hardware and software. One of ordinary skill in the art will also understand that multiple ones of the above described modules may be combined as one module, and each of the above described modules may be further divided into a plurality of sub-modules.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It should be understood that the present disclosure is not limited to the precise structures that are described above and shown in the accompanying drawings, and that various modifications and changes may be made without departing from the range of the scope thereof. It is intended that the scope of the disclosure should only be limited by the appended claims.

What is claimed is:

1. A method for activating an operating state of a mobile terminal, comprising:
measuring a first duration during which a palm contact event lasts on a screen of the mobile terminal;
measuring a second duration during which a finger touches the screen; and
determining to activate an operating state on the mobile terminal based on the first duration and the second duration.

2. The method according to claim 1, further comprising:
when it is monitored that the finger touches the screen, recording a start time at which the finger begins touching the screen;
monitoring whether a touch region of the finger on the screen exceeds a preset deviation range, beginning at the start time; and
measuring the second duration during which the touch region of the finger does not exceed the preset deviation range.

3. The method according to claim 1, wherein:
the operating state comprises an operating mode and an operating interface; and
determining to activate the operating state comprises:
determining whether the first duration exceeds a first preset threshold;
determining whether the second duration exceeds a second preset threshold;
activating the operating mode if the first duration exceeds the first preset threshold and the second duration exceeds the second preset threshold; and
activating the operating interface if the first duration exceeds the first preset threshold and the second duration exceeds a third preset threshold, wherein the third preset threshold is greater than the second preset threshold.

4. The method according to claim 3, wherein:
the operating interface comprises a single-hand operating interface and a navigation interface; and
activating the operating interface comprises:
activating the single-hand operating interface if the first duration exceeds the first preset threshold and the second duration exceeds the third preset threshold; and
activating the navigation interface, if the first duration exceeds the first preset threshold and the second duration exceeds a fourth preset threshold, wherein the fourth preset threshold is greater than the third preset threshold.

5. The method according to claim 4, wherein the operating interface further comprises at least one of a return interface or a cancel interface, and after the activating of the single-hand operating interface or the activating of the navigation interface, the method further comprises:
activating the at least one of the return interface or the cancel interface.

6. The method according to claim 1 further comprising:
determining the operating state based on an option setting of the mobile terminal.

7. A mobile terminal, comprising:
a processor; and
a memory for storing instructions executable by the processor;
wherein the processor is configured to:
measure a first duration during which a palm contact event lasts on a screen of the mobile terminal;
measure a second duration during which a finger touches the screen; and
determine to activate an operating state on the mobile terminal based on the first duration and the second duration.

8. The mobile terminal according to claim 7, wherein the processor is further configured to:
when it is monitored that the finger touches the screen, record a start time at which the finger begins touching the screen;
monitor whether a touch region of the finger on the screen exceeds a preset deviation range, beginning at the start time; and
measure the second duration during which the touch region of the finger does not exceed the preset deviation range.

9. The mobile terminal according to claim 7, wherein the processor is further configured to:
if the first duration exceeds a first preset threshold, and the second duration exceeds a second preset threshold, activate an operating mode; and
if the first duration exceeds the first preset threshold, and the second duration exceeds a third preset threshold, activate an operating interface, wherein the third preset threshold is greater than the second preset threshold.

10. The mobile terminal according to claim 9, wherein the processor is further configured to:
if it is determined that the first duration exceeds the first preset threshold, and the second duration exceeds the third preset threshold, activate a single-hand operating interface; and
if it is determined that the first duration exceeds the first preset threshold, and the second duration exceeds a fourth preset threshold, activate a navigation interface, wherein the fourth preset threshold is greater than the third preset threshold.

11. The mobile terminal according to claim 10, wherein the operating interface further comprises at least one of a return interface or a cancel interface, and after the activating of the single-hand operating interface or the activating of the navigation interface, the processor is further configured to:
activate the at least one of the return interface or the cancel interface.

12. The mobile terminal according to claim 7, wherein the processor is further configured to:
determine the operating state based on an option setting of the mobile terminal.

13. A non-transitory computer-readable storage medium having stored therein instructions that, when executed by one or more processors of a mobile terminal, cause the mobile terminal to:
measure a first duration during which a palm contact event lasts on a screen of the mobile terminal;
measure a second duration during which a finger touches the screen; and
determine to activate an operating state on the mobile terminal based on the first duration and the second duration.
